(19) United States
(12) Patent Application Publication
(10) Pub. No.: US 2010/0012339 A1
(43) Pub. Date: Jan. 21, 2010

(54) HANDLE DAMPING SYSTEM

(75) Inventors: Norbert Hahn, Hunstetten-Limbach (DE); Andreas Friedrich, Limburg (DE)

Correspondence Address: THE BLACK & DECKER CORPORATION, 701 EAST JOPPA ROAD, TW199, TOWSON, MD, 21286, US

(73) Assignee: BLACK AND DECKER INC., Newark (US)

(21) Appl. No.: 12/520,721

(22) PCT Filed: Feb. 28, 2007
(86) PCT No.: PCT/EP07/51919

§ 371 Date: Jun. 22, 2009

(30) Foreign Application Priority Data
Mar. 3, 2006 (GB) 0604253.5

(51) Int. Cl. B25D 17/04; B25D 17/24

(52) U.S. Cl. 173/162.2; 173/162.1

(57) ABSTRACT

A power tool, particularly a hammer drill, comprising; a body (4); a drive mechanism located within the body; at least one handle (10) moveably mounted on the body (4) by at least one connection point (18, 32; 16, 34); a vibration dampening mechanism connected between the body (4) and the handle (10) which reduces the amount of vibration, generated by the operation of the drive mechanism, being transferred from the body (4) to the handle (10); wherein the vibration dampening mechanism comprises a dampener (56); characterised in that the vibration dampening mechanism further comprises a restraining mechanism (52; 54) which restricts the direction of the movement of the handle (10) at the connection point (18, 32; 16, 34) where it mounts to the body to substantially the direction of the dominant vibration experienced by that connection point (18, 32; 16, 34). The restraining mechanism can comprise a pivotal lever or slide. The handle can be connected at two connection points, the movement of each one being restricted to that of the dominant vibration experienced at each connection.

The present invention relates to a power tool, and in particular, to a hammer drill or a drill having a hammer function.

EP1157788 discloses a typical hammer drill which can operate in a hammer only mode, a drill only mode and a combined hammer and drill mode. During the operation of such a hammer, a considerable amount of vibration can be generated. The vibration is caused by the operation of the rotary drive mechanism and/or the hammer mechanism, depending on the mode of operation of the hammer drill, combined with the vibratory forces applied to and experienced by the drill bit when it is being used on a work piece. These vibrations are transferred to the body of the hammer drill, which in turn are transferred to a rear handle being used by the operator to support the hammer drill. The transfer of vibration to the rear handle from the body, and subsequently to the operator's hand can not only be painful but can result in injury, particularly when the hammer drill is used over long periods of time. It is therefore desirable to minimise the amount of vibration transferred from the body to the rear handle.

One solution is to moveably mount the rear handle on body of the hammer drill to allow relative movement between the two and to locate a vibration dampening mechanism between the body and the rear handle to minimise the amount of vibration transferred to the rear handle from the body.

GB2407790 describes one such vibration dampening mechanism for a hammer drill by which the amount of vibration transferred to the rear handle from the body is reduced. However, the design of such a dampening mechanism results in the movement of the rear handle being restricted to a direction which is linear in a rearward and forward movement, in a direction parallel to the longitudinal axis of the hammer drill along which a reciprocating ram and piston travel. This does not provide the most efficient method of reducing the amount of vibration transferred to the rear handle. This is due to the nature of the vibration applied to the body of the hammer and the distribution of the masses within the hammer. This results in an overall or combined vibration which has a direction of movement which is different from a rearward and forward linear movement. Furthermore, the direction of movement of the combined vibration will vary depending on which part of the body or handle it is measured. The restriction in the direction of the movement of the rear handle in the hammer drill described in GB2407790 does not take into account.

According to the first aspect of the present invention, there is provided a power tool comprising;

a body;

a drive mechanism located within the body;

at least one handle moveably mounted on the body by at least one connection point;

a vibration dampening mechanism connected between the body and the handle which reduces the amount of vibration, generated by the operation of the drive mechanism, being transferred from the body to the handle;

wherein the vibration dampening mechanism comprises a dampener;

characterised in that the vibration dampening mechanism further comprises a restraining mechanism which restricts the direction of the movement of the handle 10 at the connection point where it mounts to the body, relative to the body, to substantially the direction of the dominant vibration experienced by that connection point.

The dominant vibration at a point is the main vibration expected to be experienced at a point when the power tool is working under certain operating conditions.

By seeking to restrict the direction of movement of the rear handle relative to the body to that of or close to the dominant vibration, which results from the sum of all types vibrations applied to the body of the hammer in combination with the distribution of the masses within the hammer, the reduction in the transfer of vibration to the rear handle from the body can be optimised.

According to the second aspect of the present invention there is provided a power tool comprising;

a body;

a drive mechanism located within the body;

at least one handle moveably mounted on the body by two connection points;

a vibration dampening mechanism connected between the body and the handle which reduces the amount of vibration, generated by the operation of the drive mechanism, being transferred from the body to the handle;

wherein the vibration dampening mechanism comprises a dampener;

and wherein the vibration dampening mechanism further comprises two restraining mechanisms, one for each connection point, each restraining mechanism restricting the direction of the movement of its corresponding connection point relative to the body to substantially a single direction,

and wherein at least one of the restraining mechanisms comprises a single lever pivotally connected at one end to its corresponding connection point and pivotally connected to the body at the other end, the orientation of the axes of pivot being parallel to each other and constraining the movement of the corresponding connection point to substantially a single direction.

According to a third aspect of the present invention there is provided a power tool comprising;

a body;

a drive mechanism located within the body;

at least one handle moveably mounted on the body at two connection points;

a vibration dampening mechanism connected between the body and the handle which reduces the amount of vibration, generated by the operation of the drive mechanism, being transferred from the body to the handle;

wherein the vibration dampening mechanism comprises a dampener;

and wherein the vibration dampening mechanism further comprises two restraining mechanisms, one for each connection point, each restraining mechanism restricting the direction of the movement of its corresponding connection point relative to the body to substantially a single direction,

and wherein at least one of the restraining mechanisms comprises a sliding mechanism comprising two parts, a first part mounted on the body, the second part mounted on the rear handle, one part linearly sliding on the other part to constrain the direction of movement of the corresponding connection point to a single direction.

Five embodiments of the present invention will now be described with reference to the enclosed drawings of which:

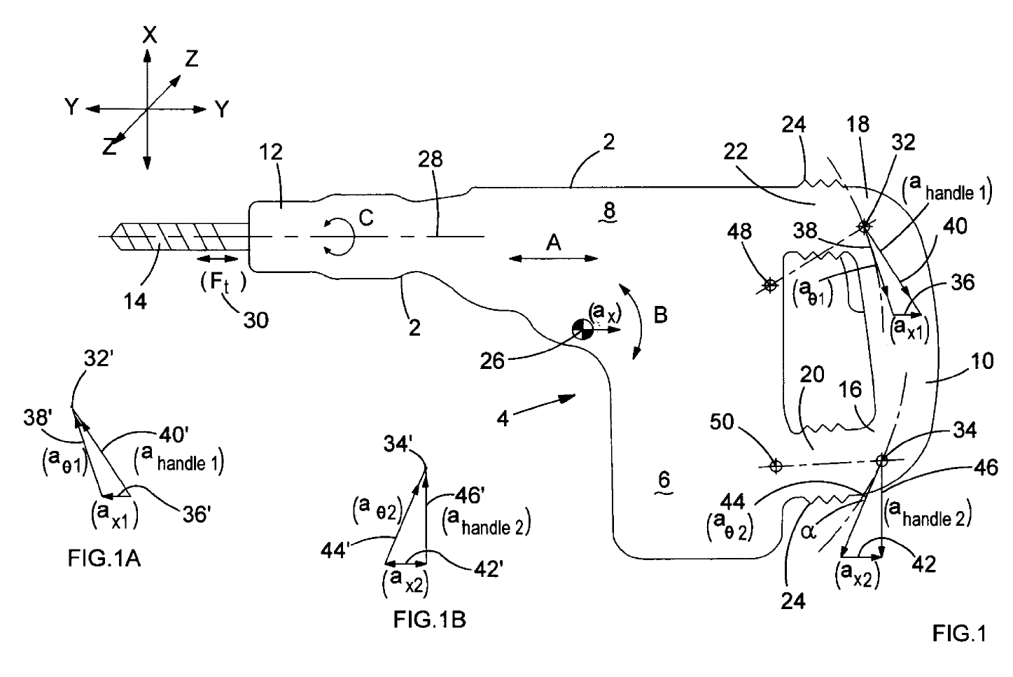

FIG. 1 shows a schematic view of a vertical cross section of a hammer drill;

FIG. 1A shows the vector addition of the two types of vibration in the reverse direction of the top and of the handle to that shown in FIG. 1;

FIG. 1B shows the vector addition of the two types of vibration in the reverse direction of the bottom end of the handle to that shown in FIG. 1;

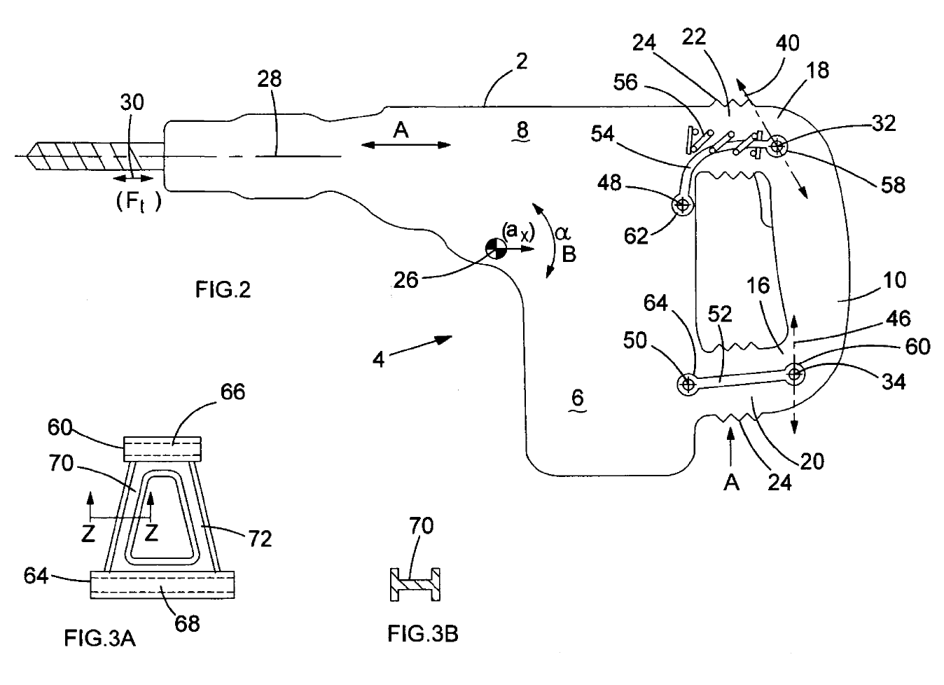

FIG. 2 shows a schematic view of a vertical cross section of a hammer drill according to the first embodiment of the present invention;

FIG. 3A shows a top view of the lower lever;

FIG. 3B shows a cross sectional view of a strut of the lever shown in FIG. 3 in the direction of Arrows Z;

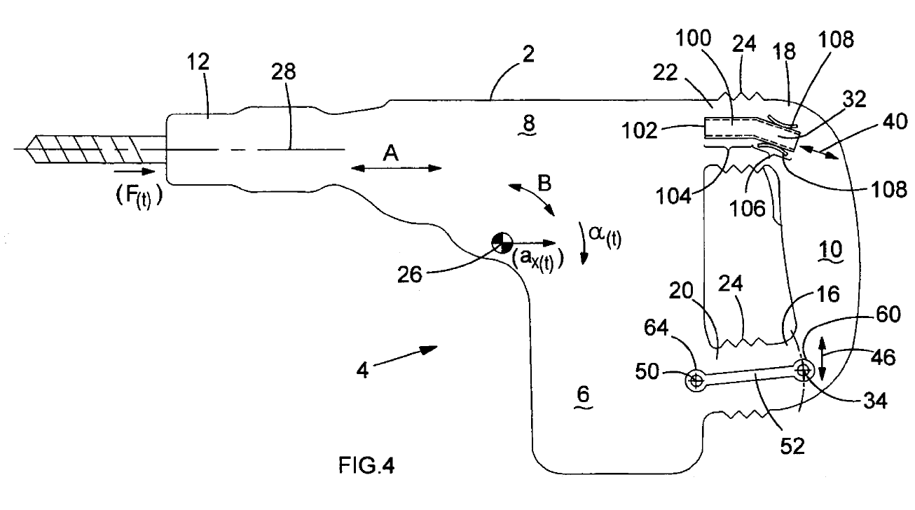

FIG. 4 shows a schematic view of a vertical cross section of a hammer drill according to the second embodiment of the present invention;

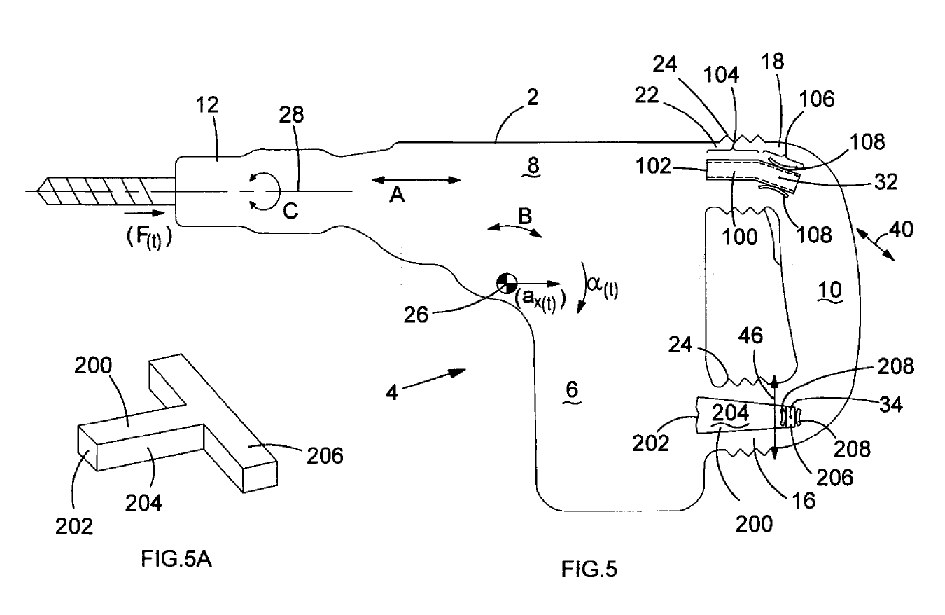

FIG. 5 shows a schematic view of a vertical cross section of a hammer drill according to the third embodiment of the present invention;

FIG. 5A shows a perspective view of the T bar shown in FIG. 5;

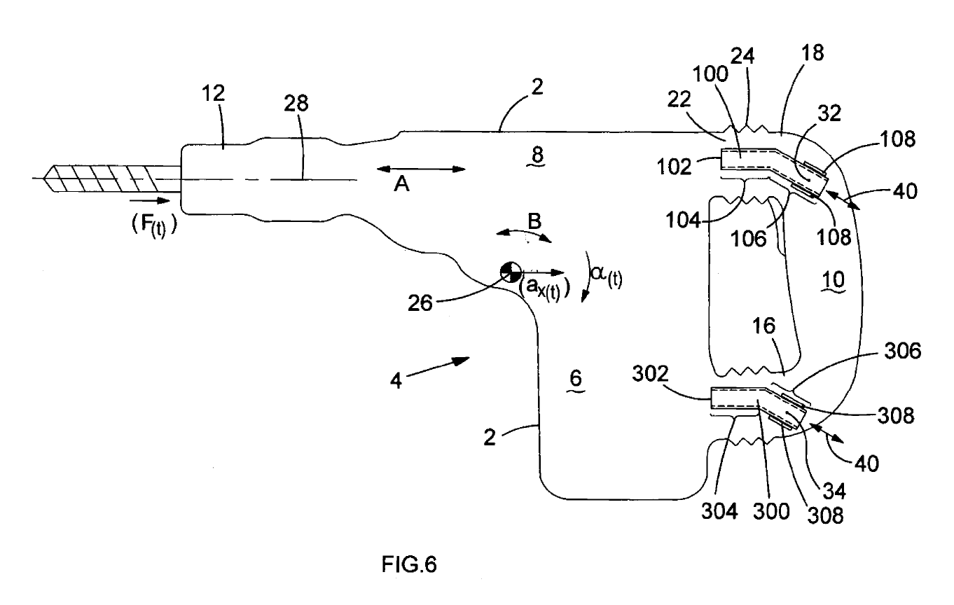

FIG. 6 shows a schematic view of a vertical cross section of a hammer drill according to the fourth embodiment of the present invention;

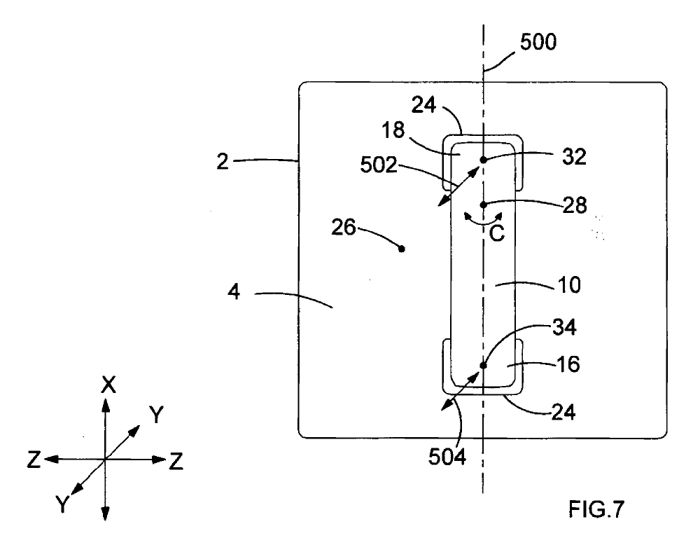

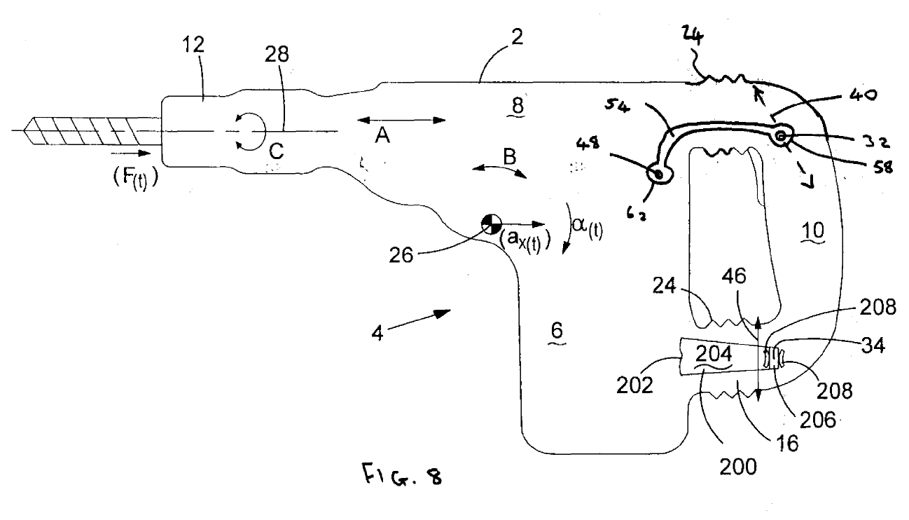

FIG. 7 shows a schematic view of the rear of a hammer drill according to the fifth embodiment of the present invention; and

FIG. 8 shows a schematic view of the rear of a hammer drill according to the sixth embodiment of the present invention.

The first embodiment of the present invention will now be described with reference to FIGS. 1, 2, 3A and 3B.

Referring to FIG. 1, the outline of a three mode of hammer drill is indicated by line 2.

The hammer drill comprises a body 4. Mounted, in well known manner, in the top half 8 of the body 4, is the spindle, rotary drive gear chain, wobble drive, piston, ram and beat piece (none of which are shown). Mounted, in well known manner, in the bottom half 6 of the body 4 is an electric motor (not shown) which is capable of driving the rotary gear chain and/or wobble drive to operate the hammer drill in either hammer only mode, drill only mode or combined hammer and drill mode depending on the type of operation selected by the user.

Mounted on the front of the body 4 is a tool holder 12, for example, an SDS plus type tool holder. Held within the tool holder 12 is a drill bit 14.

Mounted on the rear of the body 4 is a handle 10 having two ends 16,18. The handle 10 is mounted so that it can move relative to the body 4. The two ends 16,18 of the handle 10 are each connected to the body 4 via connecting sections 20,22. Located within each connecting section 20,22 is a vibration dampening mechanism (which are described in more detail below) which act between the body 4 and the handle 10 in order to reduce the amount of vibration transferred from the body 4 to the handle 10 during the operation of the hammer drill. Bellows 24 surround each of the two connecting sections 20,22.

The operation and internal mechanics of such a hammer drill do not form part of the invention and there are many such designs disclosed in prior art. It will be appreciated that the present embodiment of the invention can be utilised on any type of drill having a handle 10 moveably attached to the rear of the body 4 of the drill, irrespective of its range of modes of operation or internal design of its component parts.

The hammer drill has a centre of gravity 26. For clarity, the three directions of travel, X, Y and Z are shown in FIG. 1. The X direction, as viewed in FIG. 1, is vertical. The Y direction, as viewed in FIG. 1, is horizontal and parallel to the plane of the paper on which Figure is drawn. The Z direction, as viewed in FIG. 1, is horizontal but perpendicular to the plane of the paper on which Figure is drawn.

During the operation of the hammer drill in hammer only mode, impacts, generated by the electric motor driving the wobble drive, ram and beat piece (“hammer mechanism”), are imparted to the drill bit 14 along axis 28 (in the X direction) which is substantially parallel to and co-axial with the longitudinal axis of the drill bit. This drives the drill bit 14 forward into a work piece (not shown). The work piece, which is typically stone or brick resists the forward movement of the drill bit 14. This causes the drill bit 14 to rebound backwards, away from the work piece, towards the body 4 of the hammer, along the axis 28.

As such, a force F(t) 30 is generated on the body 4 along the axis 28 in both directions due to the impacts of the hammer mechanism and the rebound of the drill bit 14 off the work piece. This results in vibrations in the body 4 of the hammer, the direction of the driving force of the vibrations being along the axis 28. This results in linear vibrations in the body 4 in the X direction indicated by Arrow A in FIG. 1, the direction being parallel to the axis 28.

The centre of gravity is located within a vertical plane in which the axis 28 is located. As such, the centre of gravity 26 is located directly below the axis 28.

In addition to the linear vibrations (Arrow A), as the centre of gravity 26 is located below the axis 28, angular vibrations are generated about the centre of gravity 26. The direction of the vibrational forces of the angular vibrations is indicated by Arrow B in FIG. 1. This results in a twisting torque (in the X-Y plane) about the centre of gravity 26, in addition to the linear vibration (Arrow A).

The connecting sections 20,24 are constructed to reduce the amount of vibrations transferred from the body 4 to the handle 10. They are arranged to reduce both the linear vibrations (direction of Arrow A) and the angular vibrations (direction of Arrow B).

The centre 32 of the top end 18 of the handle 10 is the point where the top end 18 of the handle 10 makes contact with the top connecting section 22.

The centre 34 of the bottom end 16 of the handle 10 is the point where the bottom end 16 of the handle 10 makes contact with the bottom connecting section 20.

First, the movement 40 due to the vibrations of the top end 18 of the handle 10 will now be described.

The centre 32 of the top end 18 of the handle 10 will, if rigidly connected to the body 4, will experience two types of vibration applied to it which act in combination to produce a single resultant vibrational movement. The first type of vibration is resultant from the linear vibration of the body 4 in the direction of Arrow A. The size and direction (aₓ₁), relative to the body 4, of the vibration at the centre 32 which results from the linear vibration (Arrow A) is represented by an Arrow 36 (the direction of the Arrow 36 being the same as the direction of the vibration, the length of the arrow 36 being dependent on the amplitude of the vibration). The second type of vibration is resultant from the angular vibration of the body 4 about the centre of gravity 26 in the direction of Arrow B. The size and direction (a_{θ1}), relative to the body 4, of the vibration at the centre 32 which results from the angular vibration (Arrow B) is represented by a second Arrow 38 (the direction of the Arrow 38 being the same as the direction of the vibration, the length of the Arrow 38 being dependent on the amplitude of the vibration). The direction of the second Arrow 38 is tangential to the periphery of a circle having a centre point at the centre of gravity 26 of hammer drill. By vector adding the two Arrows 36,38 representing the two vibrations, the size and direction of the resultant vibration, relative to the body 4 at the centre 32 of the top end 18 of the handle 10, can be calculated. This is shown by a third Arrow 40 (the direction of the Arrow 40 being the same as the direction of the vibration, the length of the Arrow 40 being dependent on the amplitude of the vibration). The third Arrow 40 represents the direction and size of the “dominant” vibration at the centre 32 of the top end 18 of the handle 10 (when the hammer drill is operating in the hammer only mode).

When the body 4 is vibrating, it oscillates backwards and forwards parallel to the axis 28 and clockwise and anti-clockwise about the centre of gravity 26. It should be noted that, however, when the body 4 is travelling backwards (to the right when viewed in FIG. 1), it is travelling clockwise (when viewed in FIG. 1). This results in the direction of Arrows 36,38,40 shown in FIG. 1. When the body 4 is travelling forwards (to the left when viewed in FIG. 1), the body 4 is also travelling anti-clockwise (when viewed in FIG. 1). This would result in the direction of the Arrows being reversed as shown in FIG. 1A. Nevertheless, the direction of the Arrows 36′, 38′,40′, though reversed, is the same orientation relative to the body 4 as those shown on FIG. 1.

Second, the movement 46 due to the vibration of the bottom end 16 of the handle 10 will now be described.

The centre 34 of the bottom end 16 of the handle 10 will, if rigidly attached to the body 4, also experience two types of vibration applied to it which act in combination to produce a single vibrational movement. The first type of vibration is resultant from the linear vibration of the body 4 in the direction of Arrow A.

The size and direction relative to the body 4 (aₓ₂) of the vibration which results from the linear vibration (Arrow A) is represented by Arrow 42 (the direction of the Arrow 42 being the same as the direction of the vibration, the length of the Arrow 42 being dependent on the amplitude of the vibration). The second type of vibration is resultant from the angular vibration of the body 4 about the centre of gravity 26 in the direction of Arrow B. The size and direction relative to the body 4 (a_{θ2}) of the vibration which results from the angular vibration (Arrow B) is represented by a second Arrow 44 (the direction of the Arrow 44 being the same as the direction of the vibration, the length of the Arrow 44 being dependent on the amplitude of the vibration). [The direction of the second Arrow 44 is tangential to the periphery of a circle having a centre point at the centre of gravity 26]. By vector adding the two Arrows 42,44 representing the two vibrations, the size and direction, relative to the body 4 at the centre 34 of the bottom end 16 of the handle 10, can be calculated. This is shown by a third Arrow 46 (the direction of the Arrow 46 being the same as the direction of the vibration, the length of the Arrow 46 being dependent on the amplitude of the vibration). The third Arrow 46 represents the size and direction of the dominant vibration at the centre 34 of the bottom end 16 of the handle 10 (when the hammer is operating in a hammer only mode).

As mentioned previously, when the body 4 is vibrating, it oscillates backwards and forwards parallel to the axis 28 and clockwise and anti-clockwise about the centre of gravity. Again, it is noted that when the body 4 is travelling backwards (to the right when viewed in FIG. 1), it is travelling clockwise about the centre of gravity 26 (when viewed in FIG. 1). This results in the direction of the Arrows 42, 44, 46 shown in FIG. 1. When the body is travelling forwards (to the left when viewed in FIG. 1), the body 4 is also travelling anti-clockwise (when viewed in FIG. 1). This would result in the direction of the Arrows 42′, 44′, 46′ being as shown in FIG. 1B. Nevertheless, the direction of the Arrows 42′, 44′, 46′, though reversed, is the same orientation relative to the body 4 as those in FIG. 1.

In the present embodiment, the orientation of the dominant vibration, Arrow 46, of the centre 34 of the bottom end 16 of the handle 10 is approximately vertical. The orientation of the dominant vibration, Arrow 40, of the centre 32 of the top end 18 of the handle 10 is approximately forty five degrees to the vertical.

The present invention optimises the vibration reduction by the connecting sections 20, 22, in order to minimise the amount of vibration transferred to the handle 10 from the body 4, by restricting the direction of movement of the ends 16,18 of the handle 10, which connect to the body 4 via the connecting sections 20,22, to that of the dominant vibration at those ends 16, 18 caused by the linear vibration (Arrow A) in combination with the angular vibration (Arrow B) of the body. In other words, the movement of the top end 18 is restricted so that it can only move in the direction of the Arrow 40 relative to the body 4, and the movement of the bottom end 16 is restricted so that it can only move in the direction of the Arrow 46 relative to the body.

Once the direction of movement of two ends 16,18 of the handle 10 is restrained to be the same as the direction of the dominant vibration acting on those ends 16, 18, at the respective ends 16,18, a vibration dampening or absorption mechanism is then added to absorb the vibration. As the ends 16,18 of the handle 10 are restrained in their direction of travel to that of the dominant vibration experienced at each of the ends 16,18, the effect of the dampening mechanism is maximised.

The mechanisms by which the movement of the two ends 16,18 of the handle 10 is restrained to that of the direction of the resultant vibration applied to each end 16,18, will now be described with reference to FIG. 2.

Each of the connecting sections 20,22 comprise a lever 52,54. One end 58,60 of each lever 52,54 is pivotally connected to the centre 32, 34 of an end 16,18 of the handle 10. The other end 62,64 of each lever 52,54 is pivotally connected to the body 4. The position of the pivot points is such to restrict the direction of the travel of the ends 16,18 of the handle to the direction (Arrows 40, 46) of the dominant vibration applied to that end 16, 18.

The lower lever 52 will now be described in more detail with reference to FIGS. 2 and 3.

The first end 60 of the lower lever 52 comprises a bearing 66 which allows the first end 60 to pivot in relation to the end 16 of the handle 10 to which the first end 60 is connected. The second end 64 of the lower lever 52 also comprise a bearing 68 which allows the second end 64 to pivot in relation to the body 4 to which the second end 64 is connected. The two ends 60,64 are interconnected via two struts 70,72, each of which have an “I” profile, as shown in FIG. 3B, for rigidity. The lower lever 52 can be constructed from plastic to reduce weight.

The first end 60 of the lower lever 52 is pivotally connected to the centre 34 of the bottom end 16 of the handle 10 and is capable of pivoting about a horizontal axis which projects parallel to the Z axis. The second end 64 of the lower lever 52 is pivotally connected to the body 4 at a point indicated by reference number 50. The second end 64 is also capable of pivoting about a parallel horizontal axis which also projects parallel to the Z axis. The position of the point 50 is selected so that the resultant movement of the centre 34 of the lower end 16 of the handle 10 is restricted to that of the direction of the dominant vibration (Arrow 46).

This is achieved by locating the point 50 on the body 4 in a direction perpendicular to direction of the dominant vibration (Arrow 46), from the centre 34 of bottom end of handle 10. Thus, as the lower lever 52 pivots about point 50, the end 60 pivotally connected to the centre 34 of the handle 10 moves in direction of Arrow 46. The distance between point 50 and the centre 34 of the lower end of the handle 10 can be adjusted to suit the internal construction of the hammer drill. However, the greater the distance, the more linear the movement of the centre 34 of the bottom end 16 of the handle 10 over a greater range of movement. However, the greater the amplitude of the vibration experienced by the bottom end 16, the more the movement of the handle 10 will deviate from the direction of Arrow 46 at the extreme ends (peak of the amplitude) of the vibratory movement due to the circular movement of the lever 52 as it pivots about the point 50.

The length of the lever 52 will therefore ideally be determined by the expected amplitude of the vibrations which will be experienced by the bottom end 16 of the handle 10.

The upper lever 52 will now be described in more detail with reference to FIG. 2. The basic construction of the upper lever 54 is the same as that of the lower lever 52.

The first end 58 of the upper lever 54 comprises a bearing (not shown) which allows the first end 58 to pivot in relation to the upper end 18 of the handle 10 to which the first end 58 is connected. The second end 62 of the lower lever 52 also comprises a bearing (not shown) which allows the second end 62 to pivot in relation to the body 4 to which the second end 62 is connected. The two ends 58,62 are interconnected via two struts (not shown), each of which have an “I” profile. However, unlike the lower lever 52, which is straight along its length, the upper lever 54 is curved along its length as best seen in FIG. 2. This is due to the location of the two connection points of the lever and the desire to keep the lever 54 within the body 4 of the hammer drill without altering its outer shape 2. The upper lever 54 can be constructed from plastic to reduce weight.

The first end 58 of the upper lever 54 is pivotally connected to the centre 32 of the upper end 18 of the handle 10 and is capable of pivoting about a horizontal axis which projects parallel to the Z axis. The second end 62 of the upper lever 54 is pivotally connected to the body 4 at a point indicated by reference number 48. The second end 62 is capable of pivoting about a parallel horizontal axis which also projects parallel to the Z axis. The position of the point 48 is selected so that the resultant movement of the centre 32 of the top end 18 of the handle 10 is restricted to that of the direction of the dominant vibration (Arrow 40) acting on the centre 32.

This is achieved by locating the point 48 on the body 4 in a direction perpendicular to direction of the dominant vibration (Arrow 40), from the centre 32 of top end of handle 10. Thus, as the upper lever 54 pivots about point 48, the end 58 pivotally connected to the centre 32 of the handle 10 moves in direction of Arrow 40. As with the lower lever 52, the distance between point 48 and the centre 32 of the top end of the handle 10 can be adjusted to suit the internal construction of the hammer drill. However, the greater the distance, the more linear the movement of the centre 32 of the top end 18 of the handle 10 over a greater range of movement. However, the greater the amplitude of the vibration experienced by the top end 16, the more the movement of the handle 10 will deviate from the direction of Arrow 40 at the extreme ends (peak of the amplitude) of the vibratory movement due to the circular movement of the lever 55 as it pivots about the point 48.

The length of the lever 54 will therefore ideally be determined by the expected amplitude of the vibrations which will be experienced by the top end 18 of the handle 10.

A helical spring 56 surrounds the upper lever 54 and connects between the body 4 and the handle 10. The spring 56 acts as the vibration dampening or absorption mechanism, reducing the amount of vibration transferred to the handle 10 from the body 4. The use of such a spring 56 to reduce the amount of vibration transferred is well known in the art and as such, its operation will not be described in any further detail.

The dominant vibration calculated for the present embodiment has been calculated for hammer drill operating in hammer only mode. This is due the fact that the operation of the hammer mechanism generates by far the greatest amount of vibration in a hammer drill. When the hammer drill operates in the combined hammer and drill mode, in addition to the linear vibration (Arrow A) and angular vibrations (Arrow B), there will be a further angular vibration about axis 28 (in the X-Z plane) as indicated by Arrow C in FIG. 1. This is due to rotary action of the drill bit. However, the effect of this vibration (Arrow C) on the handle 10 is considerably less than the two vibrations (Arrow A and Arrow B) described above and therefore, for the purpose of the description of this embodiment, has been excluded. However, in the fifth embodiment of the present invention below, there is provided an example of a mechanism which can account for vibrations other than those in the X-Y plane (Arrow A and Arrow B).

A second embodiment will now be described with reference to FIG. 4. Where the same features are present in the second embodiment as the first embodiment, the same reference numbers have been used. The second embodiment is the same as the first embodiment except the mechanism by which the direction of movement of the top end 18 of the handle 10 is restrained to that of the direction of the dominant vibration has been changed. The mechanism by which the direction of movement of the bottom end 16 of the handle 10 is restrained to that of the direction of the dominant vibration is the same as the first embodiment and therefore will not be described in any more detail.

The size and direction of the dominant vibration at the centre points 32, 34 of the top 18 and bottom 16 ends of the handle 10 are the same in the second embodiment as for the first (Arrows 40, 46) and as such, their calculation has not been repeated. The dominant vibration calculated for the present embodiment has been calculated for hammer drill operating in hammer only mode.

The upper lever 54 has been replaced by a fixed bar 100. A first end 102 of the bar 100 is rigidly connected to the body 4. The bar 100 comprises two sections, 104, 106, the first section having a longitudinal axis parallel to the axis 28, the second section 106 having a longitudinal axis parallel to the Arrow 40. Formed in the handle is tubular sleeve 108 in which the second section 106 is located. The tubular sleeve 108 allows the second section 106 to slide within the sleeve along its longitudinal axis, parallel to Arrow 40. As such, the direction of movement of the top end 18 of the handle 10 is restricted.

A spring (not shown) acts as the vibration dampening or absorption mechanism which acts as a is connected between the body 4 and the handle 10 to reduce the amount of vibration transferred to the handle 10.

A third embodiment will now be described with reference to FIGS. 5 and 5A. Where the same features are present in the third embodiment as the second embodiment, the same reference numbers have been used. The third embodiment is the same as the second embodiment except the mechanism by which the direction of movement of the bottom end 16 of the handle 10 is restrained to that of the direction of the dominant vibration has been changed. The mechanism by which the direction of movement of the top end 18 of the handle 10 is restrained to that of the direction of the dominant vibration is the same as the second embodiment and therefore will not be described in any more detail.

The size and direction of the dominant vibration at the centre points 32, 34 of the top 18 and bottom 16 ends of the handle 10 are the same in the third embodiment as for the first (Arrows 40, 46) and as such, their calculation has not been repeated. The dominant vibration calculated for the present embodiment has been calculated for hammer drill operating in hammer only mode.

The lower lever 52 in the second embodiment has been replaced by a T bar 200. A first end 202 of the T bar 200 is rigidly connected to the body 4. The bar 200 comprises two sections, 204, 206, the first section having a longitudinal axis parallel to the axis 28, the second top section 206 being rigidly mounted crosswise to the end of first section 204 remote from the body 4 and having a longitudinal axis perpendicular to the longitudinal axis of the first section 204. The T bar 200 is mounted on the body 4 so that the second top section 206 is horizontal within the handle 10. Formed in the handle are two sliding bushes 208 in which the second top section 106 is located. Each end 210 of the second top section locates within a corresponding sliding bush 208. The sliding bushes 208 allows the second top section 206 to slide within the sliding bushes 208 in the direction of Arrow 46. As such, the direction of movement of the bottom end 16 of the handle 10 is restricted to that of the dominant vibration of the centre point 34.

A spring (not shown) acts as the vibration dampening or absorption mechanism which acts as a is connected between the body 4 and the handle 10 to reduce the amount of vibration transferred to the handle 10.

A fourth embodiment will now be described with reference to FIG. 6. Where the same features are present in the fourth embodiment as the second embodiment, the same reference numbers have been used. The fourth embodiment is the same as the second embodiment except the mechanism by which the direction of movement of the bottom end 16 of the handle 10 is restrained has been changed. The mechanism by which the direction of movement of the top end 18 of the handle 10 is restrained to that of the direction of the dominant vibration is the same as the second embodiment and therefore will not be described in any more detail.

The size and direction of the dominant vibration at the centre points 32, 34 of the top 18 and bottom 16 ends of the handle 10 are the same in the fourth embodiment as for the first embodiment (Arrows 40, 46) and as such, their calculation has not been repeated. The dominant vibration calculated for the present embodiment has been calculated for hammer drill operating in hammer only mode.

There are two differences in the fourth embodiment to he way in which the direction of movement of the bottom end 16 of the handle 10 is restrained has changed when compared to previous embodiments:

1) The direction of movement in which the bottom end 16 of the handle 10 is restrained is no longer the same direction as that of the dominant vibration (Arrow 46) experienced at the centre 34 of the bottom end 16, but is parallel to the direction of the dominant vibration (Arrow 40) at the top end 18 of the handle 10.

2) The mechanism by which the direction of travel of the bottom end 16 is restrained is identical to that used to restrain the top end 18.

The lower lever 52 in the second embodiment has been replaced by a fixed bar 300. A first end 302 of the bar 300 is rigidly connected to the body 4. The bar 300 comprises two sections, 304, 306, the first section 304 having a longitudinal axis parallel to the axis 28, the second section 306 having a longitudinal axis parallel to the Arrow 40. Formed in the handle 10 is tubular sleeve 308 in which the second section 306 is located. The tubular sleeve 308 allows the second section 306 to slide within the sleeve along its longitudinal axis, parallel to Arrow 40. As such, the direction of movement of the bottom end 16 of the handle 10 is restricted to a direction parallel to that of the dominant vibration experienced at the top end 18 of the handle 10.

A spring (not shown) acts as the vibration dampening or absorption mechanism which acts as a is connected between the body 4 and the handle 10 to reduce the amount of vibration transferred to the handle 10.

The reason for making the direction of movement of the bottom end parallel to the direction of movement of the top end 18, and not vice versa, is that the top end 18 experiences vibrations of a greater amplitude to that of the bottom end 16.

Though the construction of the hammer drill in the fourth embodiment provides a less efficient mechanism of reducing the transfer of the vibration from the body 4 of the hammer drill to the rear handle 10 than the three previous embodiments, as the movement of only one of the ends of the handle is restricted to that the of the dominant vibration experienced at that end, the other being parallel to it, it nevertheless provides a more efficient mechanism than prior art designs. The direction of movement of the two ends 16, 18,

A fifth embodiment will now be described with reference to FIG. 7. Where the same features are present in the fifth embodiment as the first embodiment, the same reference numbers have been used. The mechanisms by which the direction of movement of the bottom and top ends 16, 18 of the handle 10 are restrained to that of the direction of the dominant vibration are the same as the first embodiment and therefore will not be described in any more detail.

FIG. 5 shows a rear view of a hammer drill. The handle 10 is attached tot he body as shown. As such, the X, Y, Z axes are at 90 degrees to that shown in FIG. 1.

In the first embodiment, the dominant vibration was calculated for the for the hammer drill operating in the hammer only mode. Furthermore, in the first embodiment, the centre of gravity is located within a vertical plane in which the axis 28 is located. As such, the centre of gravity 26 is located directly below the axis 28.

In this, the fifth embodiment, the dominant vibration is calculated for when the hammer drill operates in the combined hammer and drill mode. Therefore, in addition to the linear vibration (Arrow A) and angular vibrations (Arrow B), there will be a further angular vibration about axis 28 (in the X-Z plane) as indicated by Arrow C in FIG. 5. This is due to rotary action of the drill bit. Furthermore, the centre of gravity is located away from a vertical plane 500 in which the axis 28 is located. As such, the centre of gravity 26 is not located directly below the axis 28. The result of this is that there are angular vibrations in the X-Y, X-Z and Y-Z planes in addition to linear vibrations in the X, Y and Z directions. This results in dominant vibrations (Arrows 502, 504) at the centres 32, 34 of the top 18 and bottom 16 ends of the handle as shown in FIG. 5 (The Arrows 502, 504 are shown as diagonal lines in FIG. 5. However, the reader will appreciated that as well as running the plane (X-Z plane) of the piece of paper on which the Arrows 502, 504 are drawn, the Arrows 502, 504, will also project into and away from (Y direction) the plane of the paper.)

The precise calculation of the size and direction of Arrows 502 and 504 has been omitted. However, it will be appreciated by the reader that the principles used in the first embodiment can be used to calculate the size and direction of the dominant vibrations at the centre 32, 34 of the ends 16, 18 of the handle. The types of mechanisms described in the first embodiment can then be utilised to restrict the direct of movement of the ends 16, 18 to that of their respective dominant vibrations.

A sixth embodiment will now be described with reference to FIG. 8. Where the same features are present in the sixth embodiment and the first embodiment, the same reference numbers have been used. The sixth embodiment is the same as the first embodiment except the mechanism by which the direction of movement of the bottom end 16 of the handle 10 is restrained to that of the direction of the dominant vibration has been changed. The mechanism by which the direction of movement of the top end 18 of the handle 10 is restrained to that of the direction of the dominant vibration is the same as the first embodiment and therefore will not be described in any more detail.

The size and direction of the dominant vibration at the centre points 32, 34 of the top 18 and bottom 16 ends of the handle 10 are the same in the sixth embodiment as for the first (Arrows 40, 46) and as such, their calculation has not been repeated. The dominant vibration calculated for the present embodiment has been calculated for hammer drill operating in hammer only mode.

The lower lever 52 in the first embodiment has been replaced by a T bar 200 in the same way as in the third embodiment. The same reference numbers have been used in relation to the T bar in the sixth embodiment as those used in the third.

A first end 202 of the T bar 200 is rigidly connected to the body 4. The bar 200 comprises two sections, 204, 206, the first section having a longitudinal axis parallel to the axis 28, the second top section 206 being rigidly mounted crosswise to the end of first section 204 remote from the body 4 and having a longitudinal axis perpendicular to the longitudinal axis of the first section 204. The T bar 200 is mounted on the body 4 so that the second top section 206 is horizontal within the handle 10. Formed in the handle are two sliding bushes 208 in which the second top section 106 is located. Each end 210 of the second top section locates within a corresponding sliding bush 208. The sliding bushes 208 allows the second top section 206 to slide within the sliding bushes 208 in the direction of Arrow 46. As such, the direction of movement of the bottom end 16 of the handle 10 is restricted to that of the dominant vibration of the centre point 34.

A spring (not shown) acts as the vibration dampening or absorption mechanism and is connected between the body 4 and the handle 10 to reduce the amount of vibration transferred to the handle 10.

1. A power tool comprising;
a body 4;
a drive mechanism located within the body;
at least one handle 10 moveably mounted on the body 4 by at least one connection point 18, 32; 16, 34;
a vibration dampening mechanism connected between the body 4 and the handle 10 which reduces the amount of vibration, generated by the operation of the drive mechanism, being transferred from the body 4 to the handle 10;
wherein the vibration dampening mechanism comprises a dampener 56;
characterised in that the vibration dampening mechanism further comprises a restraining mechanism 52; 54 which restricts the direction of the movement of the handle 10 at the connection point 18, 32; 16, 34 where it mounts to the body, relative to the body, in substantially the direction of the dominant vibration experienced by that connection point 18, 32; 16, 34.

2. A power tool as claimed in claim 1 wherein the handle 10 is mounted on the body 4 at two connection points 18, 32; 16, 34, the direction movement at the first connection point 18, 32; being restricted substantially to that of the dominant vibration experienced by the first connection point 18, 32, the direction of movement at the second connection point 16, 34 being restricted substantially to that of the dominant vibration experienced by the second connection point 16, 34.

3. A power tool as claimed in claim 1 wherein the handle 10 is mounted on the body 4 at a plurality of connection points 18, 32; 16, 34, the direction of movement of each connection point 18, 32; 16, 34 being restricted substantially to that of the dominant vibration experienced by that connection point 18, 32; 16, 34.

4. A power tool as claimed in claim 1 wherein the handle 10 is mounted on the body 4 at two connection points 18, 32; 16, 34, the direction of movement at the first connection point 18, 32 being restricted substantially to that of the dominant vibration experience by the first connection point 18, 32, the direction of movement at the second connection point 16, 34 being restricted so that it is substantially parallel to the direction of movement of the first connection point 18, 32.

5. A power tool as claimed in claim 1 wherein the handle 10 is mounted on the body 4 at a plurality of connection points 18, 32; 16, 34, the direction of movement of one connection point 18, 32; being restricted substantially to that of the dominant vibration experienced by that connection point 18, 32 the direction movement at the other connection points 16, 34 being restricted so that they are substantially parallel to the direction of movement of the first connection point 18, 32.

6. A power tool as claimed in claim 1 wherein the direction of movement is restricted to that of the connection point which experiences the greatest dominant vibration.

7. A power tool as claimed in claim 1 wherein the power tool is capable of operating in a plurality of modes of operation wherein the direction movement of the at least one connection point 18, 32; 16, 34 is restricted to the direction of the movement of the dominant vibration experienced by that connection point 18, 32; 16, 34 when the power tool is operated in one of the modes of operation.

8. A power tool as claimed in claim 7 wherein the direction of movement is restricted to the direction of the movement of the dominant vibration experienced by the connection point in the mode in which the connection point experiences the greatest dominant vibration.

9. A power tool as claimed in claim 7 wherein the power tool is capable of operating in a plurality of modes of operation wherein the direction movement of the at least one connection point is restricted to an average of the directions of the dominant vibrations experienced by that connection point when operated in each of the modes of operation.

10. A power tool as claimed in claim 1 wherein the restraining mechanism comprises a lever 52; 54 pivotally connected at one end 58; 60 to the connection point 18, 32; 16, 34 and pivotally connected to the body 4 at the other end 62; 64, the orientation of the axes of pivot being such to constrain the pivotal movement of the connection point 18, 32; 16, 34.

11. A power tool as claimed in claim 10 wherein the length of the lever 52; 54 is dependent on the amplitude of the dominant vibration.

12. A power tool as claimed in claim 1 wherein the restraining mechanism comprises a sliding mechanism comprising two parts, a first part 100 mounted on the body 4, the second part 108 mounted on the rear handle 10, one part linearly sliding on the other part.

13. A power tool as claimed in claim 10 wherein, when the handle is mounted on the body at two or more connection points; each connection point is connected to the body using a lever as claimed in either of claim 10 or 11 or a sliding mechanism as claimed in claim 12.

14. A power tool as claimed in claim 1 wherein the dampener is a spring.

15. A power tool comprising;
a body 4;
a drive mechanism located within the body;
at least one handle 10 moveably mounted on the body 4 by two connection points;
a vibration dampening mechanism connected between the body 4 and the handle 10 which reduces the amount of vibration, generated by the operation of the drive mechanism, being transferred from the body 4 to the handle 10;
wherein the vibration dampening mechanism comprises a dampener 56;
and wherein the vibration dampening mechanism further comprises two restraining mechanisms, one for each connection point, each restraining mechanism restricting the direction of the movement of its corresponding connection point relative to the body to substantially a single direction,
and wherein at least one of the restraining mechanisms comprises a single lever pivotally connected at one end to its corresponding connection point and pivotally connected to the body 4 at the other end, the orientation of the axes of pivot being parallel to each other and constraining the movement of the corresponding connection point to substantially a single direction.

16. A power tool as claimed in claim 15 wherein both restraining mechanisms comprise a single lever, each being pivotally connected at one end to its corresponding connection point and each being pivotally connected to the body 4 at the other end, the orientation of the axes of pivot for each lever being parallel and constraining the movement of the corresponding connection point to substantially a single direction.

17. A power tool as claimed in claim 16 wherein the all of the axes of pivot of the two levers are parallel.

18. A power tool as claimed in claim 15 wherein the second restraining mechanism comprises a sliding mechanism comprising two parts, a first part mounted on the body 4, the second part mounted on the rear handle 10, one part linearly sliding on the other part to restrict the direction of movement of the connection point to a single direction.

19. A power tool as claimed in claim 15 wherein the direction of movement of the first connection point is different to that of the second.

20. A power tool comprising;
a body 4;
a drive mechanism located within the body;
at least one handle 10 moveably mounted on the body 4 at two connection points;
a vibration dampening mechanism connected between the body 4 and the handle 10 which reduces the amount of vibration, generated by the operation of the drive mechanism, being transferred from the body 4 to the handle 10;
wherein the vibration dampening mechanism comprises a dampener 56;
and wherein the vibration dampening mechanism further comprises two restraining mechanisms, one for each connection point, each restraining mechanism restricting the direction of the movement of its corresponding connection point relative to the body to substantially a single direction,
and wherein at least one of the restraining mechanisms comprises a sliding mechanism comprising two parts, a first part mounted on the body 4, the second part mounted on the rear handle 10, one part linearly sliding on the other part to constrain the direction of movement of the corresponding connection point to a single direction.

21. A power tool as claimed in claim 20 wherein both restraining mechanisms comprise sliding mechanisms, each sliding mechanism comprising two parts, a first part mounted on the body 4, a second part 108 mounted on the rear handle 10, one part linearly sliding on the other part to constrain the movement of the corresponding connection point to a single direction.

22. A power tool as claimed in claim 20 wherein the second restraining mechanism comprises a lever pivotally connected at one end to its corresponding connection point and pivotally connected to the body 4 at the other end, the orientation of the axes of pivot being parallel and constraining the pivotal movement of the connection point to substantially a single direction.

23. A power tool as claimed in claim 20 wherein the direction of movement of the first connection point is different to that of the second.

24. A power tool as claimed in claim 20 wherein each restraining mechanism restricts the direction of the movement of the handle 10 at its corresponding connection point relative to the body to substantially the direction of the dominant vibration experienced by that connection point.

25. A power tool as claimed in claim 20 wherein the power tool is a hammer drill.

26. A power tool as claimed in claim 25 wherein the hammer drill is capable of operating in in least a hammer only mode, the movement of the connection point being restricted to that of the direction of movement of dominant vibration experienced by the connection point when the hammer drill is in the hammer only mode of operation.

27. A power tool as claimed in claim 25 wherein the body comprises an axis 28 along which impacts can be imparted to a drill bit 14 and a centre of gravity, the centre of gravity being located away from the axis 28.

28. A power tool as claimed in claim 27 wherein, during normal use and the axis is horizontal, the centre of gravity is located below the axis 28.

29. A power tool as claimed in claim 20 wherein the direction of the dominant vibration at the connection point comprises component vibrations in at least two directions of travel.

30. A power tool as claimed in claim 29 wherein the direction of the dominant vibration at the connection point comprises component vibrations in the X and Y directions of travel, X and Z directions of travel, Y and Z directions of travel, or X, Y and Z directions of travel.
